(19) United States
(12) Patent Application Publication
(10) Pub. No.: US 2026/0244331 A1
(43) Pub. Date: Aug. 20, 2026

(54) MEDIA INFORMATION PROCESSING METHOD, ELECTRONIC DEVICE, AND STORAGE MEDIUM

(71) Applicant: TENCENT TECHNOLOGY (SHENZHEN) COMPANY LIMITED, Shenzhen (CN)

(72) Inventor: Peifu YIN, Shenzhen (CN)

(21) Appl. No.: 19/646,171

(22) Filed: Apr. 13, 2026

Related U.S. Application Data
(63) Continuation of application No. PCT/CN2024/134143, filed on Nov. 25, 2024.

(30) Foreign Application Priority Data
Jan. 2, 2024 (CN) 202410015396.0

(51) Int. Cl. G06F 3/04855; G06F 3/0483; G06T 11/10

(52) U.S. Cl. CPC G06F 3/04855; G06F 3/0483; G06T 11/10; G06T 2200/24

(57) ABSTRACT

A media information processing method performed by an electronic device and includes: sliding media information on an information page in response to a sliding operation for the media information on the information page; displaying, in response to that the media information involves a target topic, topic indication information corresponding to the target topic, the topic indication information being configured for indicating that the media information contains topic content corresponding to the target topic; and displaying the topic content on the information page in response to a trigger operation for the topic indication information.

### CROSS-REFERENCES TO RELATED APPLICATIONS

This application is a continuation application of PCT Patent Application No. PCT/CN2024/134143, filed on November 25, 2024, which claims priority to Chinese Patent Application No. 202410015396.0, filed on January 2, 2024, the content of which is incorporated herein by reference in its entirety.

### FIELD OF THE TECHNOLOGY

The present disclosure relates to mobile internet technologies, and in particular, to a media information processing method and apparatus, an electronic device, a medium, and a program product.

### BACKGROUND OF THE DISCLOSURE

With the development of mobile internet technologies, users can engage in conversational chats via instant messaging, and during these chats, they may carry out multiple rounds of discussion on a specific topic. The information related to the topic is clear and well understood to users who are participating in the discussion. However, users who join the conversational chat later may be unable to perceive existence of the topic. Or, even if learning about the existence of the topic through other users, the users have to scroll through the chat interface to browse historical conversation record if they want to view topic content. When the topic content has been buried by a large quantity of subsequent conversation messages, it may take a long time to scroll to the relevant position of the topic content, resulting in low efficiency of obtaining the topic content.

### SUMMARY

An embodiment of the present disclosure provides a media information processing method performed by an electronic device. The method includes: sliding media information on an information page in response to a sliding operation for the media information on the information page; displaying, in response to that the media information involves a target topic, topic indication information corresponding to the target topic, the topic indication information being configured for indicating that the media information contains topic content corresponding to the target topic; and displaying the topic content on the information page in response to a trigger operation for the topic indication information.

Another embodiment of the present disclosure provides an electronic device. The electronic device includes one or more processors and a memory containing computer-executable instructions or a computer program that, when being executed, cause the one or more processors to perform: sliding media information on an information page in response to a sliding operation for the media information on the information page; displaying, in response to that the media information involves a target topic, topic indication information corresponding to the target topic, the topic indication information being configured for indicating that the media information contains topic content corresponding to the target topic; and displaying the topic content on the information page in response to a trigger operation for the topic indication information.

Another embodiment of the present disclosure provides a non-transitory computer-readable storage medium containing computer-executable instructions or a computer program that, when being executed, cause at least one processor for performing: sliding media information on an information page in response to a sliding operation for the media information on the information page; displaying, in response to that the media information involves a target topic, topic indication information corresponding to the target topic, the topic indication information being configured for indicating that the media information contains topic content corresponding to the target topic; and displaying the topic content on the information page in response to a trigger operation for the topic indication information.

### BRIEF DESCRIPTION OF THE DRAWINGS

FIG. 1 is a schematic diagram of an architecture of a media information processing system 100 according to an embodiment of the present disclosure.

FIG. 2 is a schematic diagram of a structure of an electronic device 500 according to an embodiment of the present disclosure.

FIG. 3 is a schematic flowchart of a media information processing method according to an embodiment of the present disclosure.

FIG. 4 is a schematic diagram of displaying topic indication information according to an embodiment of the present disclosure.

FIG. 5 is a schematic diagram of expansion of a progress bar according to an embodiment of the present disclosure.

FIG. 6 is a schematic diagram of displaying topic indication information according to an embodiment of the present disclosure.

FIG. 7 is a schematic diagram of displaying topic indication information according to an embodiment of the present disclosure.

FIG. 8 is a schematic diagram of displaying topic indication information according to an embodiment of the present disclosure.

FIG. 9 is a schematic diagram of displaying topic indication information according to an embodiment of the present disclosure.

FIG. 10 is a schematic diagram of displaying extended topic content according to an embodiment of the present disclosure.

### DESCRIPTION OF EMBODIMENTS

To make the objectives, technical solutions, and advantages of the present disclosure clearer, the following describes the present disclosure in further detail with reference to the accompanying drawings. The described embodiments are not to be considered as a limitation to the present disclosure. All other embodiments obtained by a person of ordinary skill in the art without creative efforts shall fall within the protection scope of the present disclosure.

In embodiments of the present disclosure, relevant data (for example, a trigger operation of a user) such as user information are involved. When embodiments of the present disclosure are applied to specific products or technologies, user permission or consent is required, and collection, use, and processing of relevant data need to comply with relevant laws, regulations, and standards of relevant countries and regions.

In the following descriptions, related "some embodiments" describe a subset of all suitable embodiments. However, the "some embodiments" may be the same subset or different subsets of all the suitable embodiments, and may be combined with each other without conflict.

In the following descriptions, the related term "first, second, ..." is merely intended to distinguish between similar objects rather than represent a particular sequence of the objects. A particular sequence or a chronological order indicated by "first, second, ..." may be changed if permitted, so that the embodiments of the present disclosure described herein can be implemented in a sequence other than the sequence illustrated or described herein.

In the embodiments of the present disclosure, the term "module" or "unit" refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules or units. In addition, each module or unit may be a part of an overall module or unit including a function of the module or unit.

Unless otherwise defined, meanings of all technical and scientific terms used in this specification are the same as those usually understood by a person skilled in the art to which the present disclosure belongs. Terms used in this specification are merely intended to describe the purpose of the embodiments of the present disclosure, but are not intended to limit the present disclosure.

Before the embodiments of the present disclosure are further described in detail, a description is made on nouns and terms in the embodiments of the present disclosure, and the nouns and terms in the embodiments of the present disclosure are applicable to the following explanations.
1. A client is an application program that runs in a terminal and that is configured for providing various services, for example, a video playback client, an instant messaging client, a short video client, a learning client, or a game client.
2. In response to is configured for indicating a dependent condition or state of a performed operation. When the dependent condition or state is met, one or more performed operations may be real-time or may have a set delay. Unless otherwise specified, there is no restriction on an execution order of the plurality of performed operations.

Embodiments of the present disclosure provide a media information processing method and apparatus, an electronic device, a computer-readable storage medium, and a computer program product, to indicate existence of a target topic on an information page, and improve efficiency of obtaining topic content. An exemplary application of the electronic device provided in the embodiments of the present disclosure is described below. The electronic device provided in the embodiments of the present disclosure may be implemented as various types of user terminals such as a laptop, a tablet computer, a desktop computer, a set-top box, a mobile device (for example, a mobile phone, a portable music player, a personal digital assistant, a dedicated messaging device, or a portable game device), a smartphone, a smart speaker, a smartwatch, a smart television, or an in-vehicle terminal, or may be implemented as a server. An exemplary application in which the device is implemented as a terminal is described below.

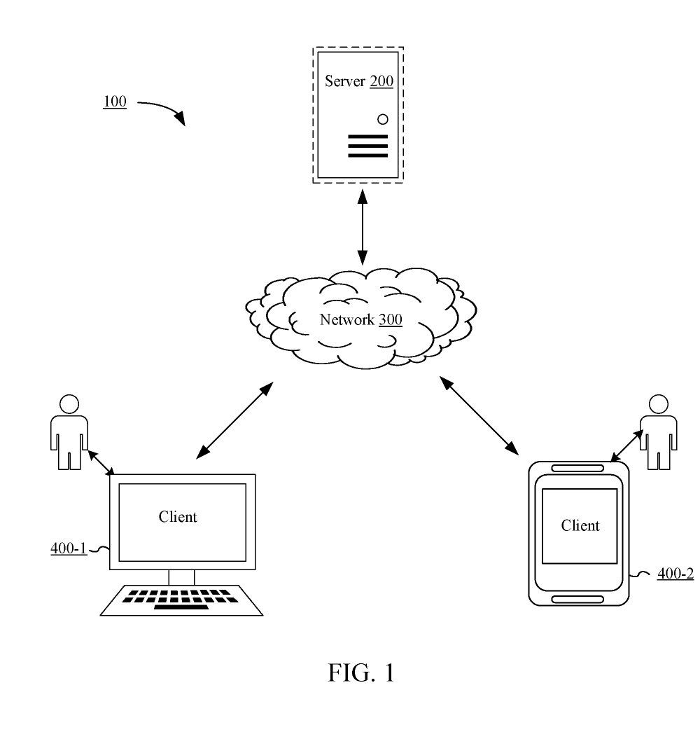

FIG. 1 is a schematic diagram of an architecture of a media information processing system 100 according to an embodiment of the present disclosure. To support an exemplary application, a terminal (for example, a terminal 400-1 and a terminal 400-2 are shown) is connected to a server 200 through a network 300. The network 300 may be a wide area network, a local area network, or a combination of the wide area network and the local area network.

In some embodiments, the server 200 may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The terminal 400 may be a smartphone, a tablet computer, a laptop, a desktop computer, a smart speaker, a smartwatch, an in-vehicle terminal, or the like, but is not limited thereto. The terminal may be connected directly or indirectly to the server in a wired or wireless communication manner, which is not limited according to various embodiments of the present disclosure.

In actual application, a client is set on the terminal, and the server is a background server corresponding to the client. When a user opens the client on the terminal to browse information, media information is displayed on an information page of the terminal, the media information is slid on the information page in response to a sliding operation for the media information on the information page, and a topic identification request for the media information is transmitted to the server 200. The server 200 performs topic identification on the media information in response to the topic identification request, and returns an identification result to the terminal. The terminal displays topic indication information corresponding to a target topic when the identification result represents that the media information involves the target topic. The topic indication information is configured for indicating that there is topic content corresponding to the target topic. The topic content is displayed on the information page in response to a trigger operation for the topic indication information.

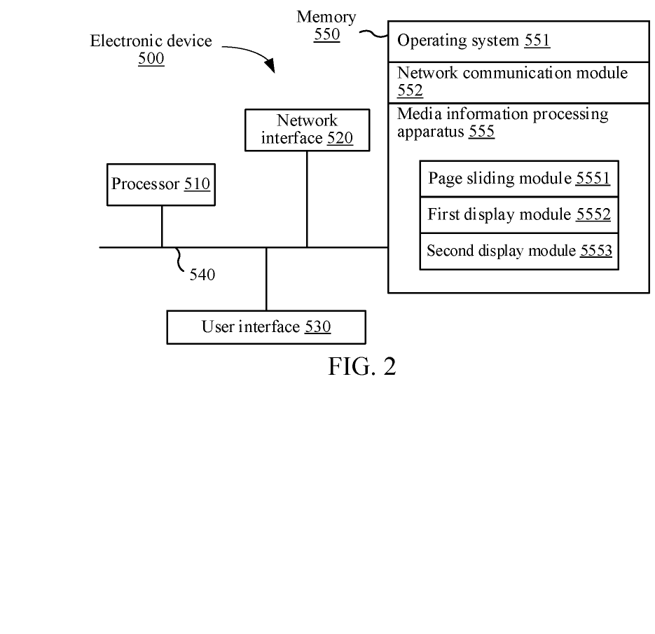

FIG. 2 is a schematic diagram of a structure of an electronic device 500 according to an embodiment of the present disclosure. An example in which the electronic device 500 is the terminal in FIG. 1 is used. The electronic device 500 shown in FIG. 2 includes: at least one processor 510, a memory 550, at least one network interface 520, and a user interface 530. Components in the electronic device 500 are coupled together through a bus system 540. The bus system 540 is configured to implement connection and communication between the components. In addition to a data bus, the bus system 540 further includes a power bus, a control bus, and a state signal bus. However, for clarity of description, all types of buses in FIG. 2 are marked as the bus system 540.

The processor 510 may be an integrated circuit chip having a signal processing capability, for example, a general purpose processor, a digital signal processor (DSP), another programmable logic device, discrete gate or transistor logic device, or discrete hardware component, or the like. The general purpose processor may be a microprocessor or any conventional processor, or the like.

The memory 550 includes a volatile memory or a non-volatile memory, or may include both a volatile memory and a non-volatile memory. The non-volatile memory may be a read-only memory (ROM). The volatile memory may be a random access memory (RAM). The memory 550 described in this embodiment of the present disclosure is to include any suitable type of memory. In some embodiments, the memory 550 includes one or more storage devices away from the processor 510 in physical positions.

In some embodiments, the memory 550 may store data to support various operations. Examples of the data include a program, a module, and a data structure, or a subset or a superset thereof, which are exemplified below.

An operating system 551 includes system programs configured for processing various basic system services and performing a hardware-related task, for example, a framework layer, a core library layer, and a driver layer, and is configured for implementing various basic services and processing a hardware-based task. A network communication module 552 is configured to reach another electronic device through one or more (wired or wireless) network interfaces 520. Exemplary network interfaces 520 include: Bluetooth, wireless compatibility authentication (WiFi), a universal serial bus (USB), and the like.

In some embodiments, the media information processing apparatus provided in the embodiments of the present disclosure may be implemented in a software manner. The media information processing apparatus provided in the embodiments of the present disclosure may be provided as various software embodiments, including various forms such as an application program, software, a software module, a script, or code. FIG. 2 shows a media information processing apparatus 555 stored in the memory 550. The media information processing apparatus 555 may be software in a form of a program, a plug-in, and the like, and includes a series of modules, including a page sliding module 5551, a first display module 5552, and a second display module 5553. These modules are logical, and therefore may be randomly combined in different manners to form other embodiments or further split based on an implemented function. Functions of the modules are described below.

In some other embodiments, the apparatus provided in embodiments of the present disclosure may be implemented in a hardware manner. In an example, the apparatus provided in embodiments of the present disclosure may be a processor in a form of a hardware decoding processor, programmed to perform the xx method provided in embodiments of the present disclosure. For example, the processor in the form of the hardware decoding processor may use one or more application specific integrated circuits (ASICs), a digital signal processor (DSP), a programmable logic device (PLD), a complex programmable logic device (CPLD), a field-programmable gate array (FPGA), or another electronic component.

In some embodiments, the terminal or the server may implement the method(s) provided in embodiments of the present disclosure by running various computer-executable instructions or computer programs. For example, the computer-executable instructions may be a microprogram-level command, machine instructions, or software instructions. The computer program may be a native program or a software module in an operating system; may be a local application (APP), namely, a program that needs to be installed in the operating system for running, such as an instant messaging APP; or may be a mini program that may be embedded in any APP, namely, a program that only needs to be downloaded into a browser environment for running. In conclusion, the computer-executable instructions may be instructions in any form, and the computer program may be an application program, a module, or a plug-in in any form.

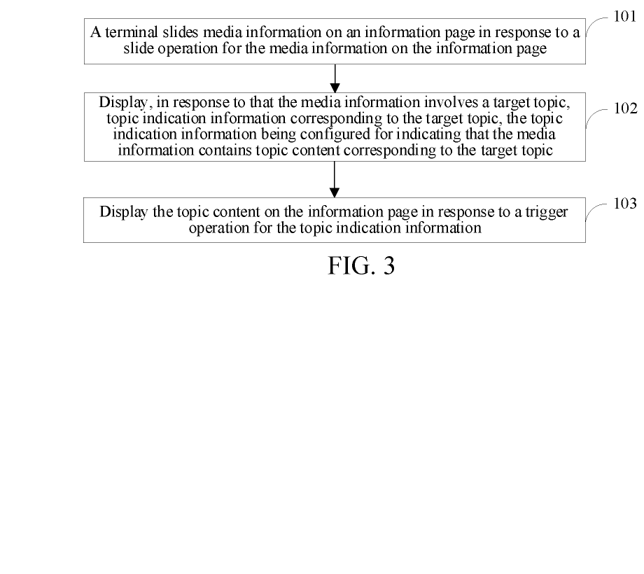

As described above, the media information processing method provided in embodiments of the present disclosure may be implemented by various types of electronic devices, for example, may be independently performed by the terminal in FIG. 1, or may be cooperatively performed by the terminal and the server 200 in FIG. 1. Next, an example in which the media information processing method provided in embodiments of the present disclosure is independently performed by the terminal in FIG. 1 is used for description. FIG. 3 is a schematic flowchart of a media information processing method according to an embodiment of the present disclosure. Descriptions are to be provided with reference to operations shown in FIG. 3.

Operation 101: A terminal slides media information on an information page in response to a slide operation for the media information on the information page.

In actual application, a client, such as an instant messaging client, a video playback client, a short video client, a learning client, a game client, or the like, is configured on the terminal. When a user opens the client on the terminal to browse information, to-be-browsed media information is displayed on an information page of the terminal. Types of the media information include at least one of text, emoji, image, audio, and/or video.

The information page is a page that is provided in the client configured on the terminal and that is configured for displaying the media information, for example, an information page like conversation interface, friend activity, Moments, Shuoshuo, forum, video stream. With a sliding operation (or a dragging operation or another operation) on the information page, specific content of the media information displayed on the information page (that is, content currently displayed on a view interface of the terminal) synchronously changes with sliding of the information page. In this way, the user may move the information page by using a related operation, to view more media information on the information page.

Operation 102: Display, in response to that the media information involves a target topic, topic indication information of the target topic, the topic indication information being configured for indicating that there is topic content corresponding to the target topic in the media information.

The topic is a subject of discussion, communication, or sharing about the media information on the information page by the user. For example, the topic may be a subject of discussion about current news, social practices, popular trends, and the like, and includes, but is not limited to: network, interpersonal relationship, movie, music, sports, book, festival celebration, delicacy, pet, lame joke, worldview, values, and the like. The target topic may be any one of the foregoing topics.

In some embodiments, the terminal may perform topic identification on the media information to determine whether the media information involves the target topic, for example, input the media information into a big language model (a trained big language model configured for topic identification) to perform topic prediction and classification, and when the target topic is predicted, determine that the media information involves the target topic. Alternatively, the terminal may first perform topic extraction on the media information, perform matching between an extracted topic and a candidate topic in a topic library (configured for storing a plurality of preset candidate topics) (for example, calculate a similarity between the extracted topic and the candidate topic), use a candidate topic matching the extracted topic as the target topic when there is the candidate topic matching the extracted topic (for example, when a similarity value exceeds a similarity threshold), and determine that the media information involves the target topic.

In some other embodiments, when performing topic identification on the media information, the terminal may first identify, from the media information based on object data (such as a hobby and historical interaction behavior) of a current object (to be specific, a user performing a sliding operation for the media information on the information page), a target topic matching the current object. For example, the terminal first performs topic extraction on the media information, performs matching between an extracted topic and a candidate topic in a topic library, and after a candidate topic (which may be multiple) matching the extracted topic is screened out from the topic library, further performs matching between the object data of the current object and the screened candidate topic matching the extracted topic, for example, extracts a topic characteristic from the candidate topic matching the extracted topic, extracts an object characteristic from the object data, and performs matching between the topic characteristic and the object characteristic, for example, calculates a similarity between the topic characteristic and the object characteristic. When the similarity between the topic characteristic and the object characteristic exceeds a similarity threshold (which may be set based on an actual requirement), the screened candidate topic matching the extracted topic matches the object data of the current object. In this case, the candidate topic matching the object data of the current object is determined as the target topic, and it is determined that the media information involves the target topic. In this way, when different users browse same media information, perceived target topics may be different. For example, when different conversation objects (that is, users) in a same conversation group browse same conversation information in the conversation group, a target topic perceived by each conversation object matches object data of each conversation object. When object data of different conversation objects is different, target topics perceived by different conversation objects may be different. For example, when a conversation object A in the same conversation group slides a conversation message in the conversation group, for the conversation object A, an identified target topic is "movie", and when a conversation object B in the conversation group slides the same conversation message, for the conversation object B, an identified target topic is "sports". In this way, accuracy of the topic identification and pertinence of topic perception are improved, and interference from an irrelevant topic to the user can be avoided. For example, in the foregoing example, interference from the topic "movie" to the conversation object B, and interference from the topic "sports" to the conversation object A can be avoided.

In some embodiments, after the terminal slides the media information on the information page, in a process of sliding the media information, the terminal may further display a progress bar at an edge position on the information page, the progress bar being configured for indicating a sliding progress for the information page. Correspondingly, the terminal may display the topic indication information corresponding to the target topic in the following manner: highlighting a target area on the progress bar, and using the highlighted target area as the topic indication information corresponding to the target topic, where a relative position of the target area on the progress bar is configured for indicating an involved position of the target topic in the media information.

In actual application, in the process of sliding the media information, the progress bar (having a particular width or length) may be displayed at the edge position (for example, a rightmost position, a lowermost position, or another non-middle area on the information page) on the information page, to indicate the sliding progress for the information page (or the media information on the information page), the target area is highlighted on the progress bar, and the highlighted target area is used as the topic indication information, to indicate that the media information involves the target topic, and that there is the topic content corresponding to the target topic in the media information.

The sliding progress that is of the media information and that is indicated by the progress bar can reflect, to some extent, a relative position, in the entire media information on the information page, of currently displayed information content (partial content of the media information) on the information page. The relative position of the target area on the progress bar can reflect, to some extent, the involved position of the target topic in the media information. The involved position refers to a relative position, all content of the media information, of the topic content of the target topic. For example, if the topic content corresponding to the target topic appears at one third of all the content of the media information, the target area is located at one third of the progress bar.

That the target area is prominently displayed on the progress bar may include displaying the target area on the progress bar by using a target display style, to distinguish from an area other than the target area on the progress bar. For example, the target area on the progress bar is displayed by using a first preset filling color (that is, the target display style), and the area other than the target area on the progress bar is displayed by using a second preset filling color (which is different from the first preset filling color). For example, the target area on the progress bar is displayed in green, and the another area on the progress bar is displayed in gray, to distinguish the target area from the another area. For another example, the target area is displayed in a highlighted manner (that is, the target display style), and the another area on the progress bar is displayed in grayscale, to distinguish the target area from the another area. In this way, highlighting the target area can provide the user with a distinctive indication, so that the user perceives existence of the target topic.

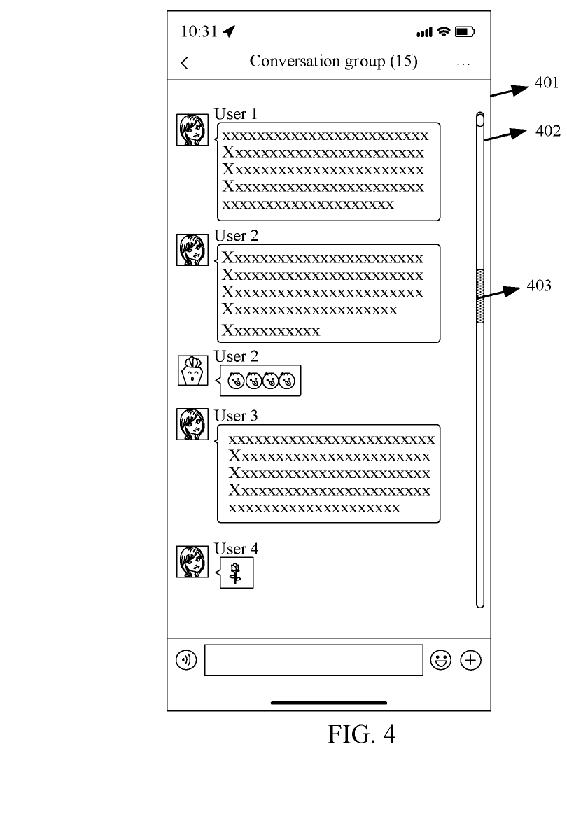

FIG. 4 is a schematic diagram of displaying topic indication information according to an embodiment of the present disclosure. An example in which an information page is a conversation page 401 in a group is used. Conversation information (that is, the foregoing media information) is displayed on the conversation page 401, and a conversation object may change, by sliding the conversation page 401, conversation information currently displayed on the information page. When the conversation object slides (or drags or presses) the conversation page 401, a progress bar 402 is displayed at an edge position (for example, the rightmost side) on the conversation page, and a target area 403 is highlighted on the progress bar 402 when the conversation information involves a target topic, to indicate, by using the highlighted target area 403, a relative position, in all content in the conversation information, of topic content corresponding to the target topic. In this way, the conversation object clearly perceives, by using the target area on the progress bar, existence of the target topic and an approximate position of the topic content corresponding to the target topic in the conversation information.

In some embodiments, the terminal controls, in response to a trigger operation for the progress bar, the progress bar to be expanded, and controls the target area to be synchronously expanded as the progress bar is expanded, where the target area is expanded to improve trigger convenience for the area.

A plurality of trigger forms of the trigger operation may be included. For example, the trigger operation may be a click/tap operation, a double-click/double-tap operation, a long-press operation, or another operation. The form of the trigger operation is not limited according to various embodiments of the present disclosure.

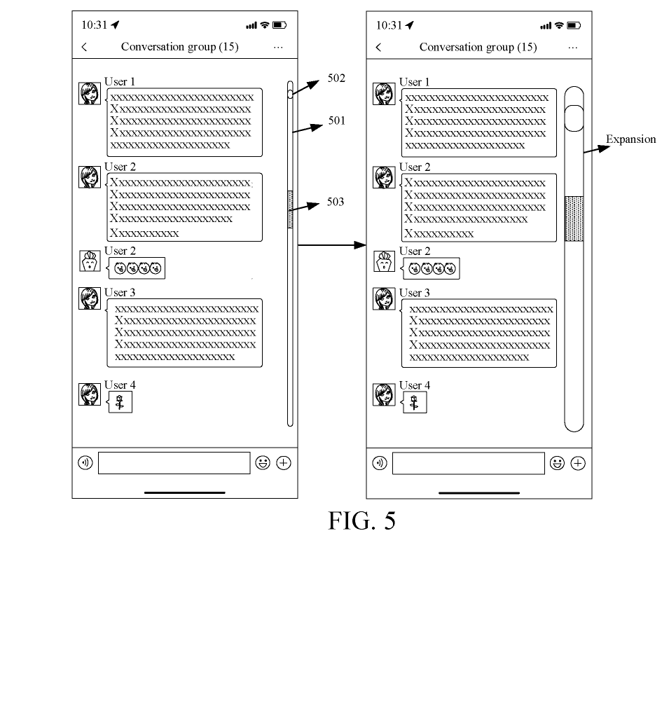

FIG. 5 is a schematic diagram of expansion of a progress bar according to an embodiment of the present disclosure. In actual application, when a user triggers (for example, presses) a progress bar 501 (because the progress bar 501 may be dragged or slid, a slider 502 for dragging or sliding may be set on the progress bar 501, and pressing the progress bar 501 may be considered as pressing the slider 502 on the progress bar), the progress bar 501 may be controlled to be expanded, to increase a width of the progress bar, and a target area 503 on the progress bar is synchronously controlled to be expanded, to increase a width of the target area 503 accordingly (in other words, increase an area occupied by the target area on the progress bar). In this way, operability and convenience of successfully triggering the target area can be improved, so that the user can better view information such as topic indication information and topic content of a target topic.

In some embodiments, the terminal may highlight the target area on the progress bar in the following manner: in response to that there are a plurality of involved positions of the target topic in the media information, highlighting, on the progress bar, sub-areas corresponding to the involved positions, and using an area obtained by combining all the sub-areas as the target area.

In actual application, for the same target topic, there may be a plurality (two or more) of involved positions in the media information. An example in which the information page is the conversation interface and the media information is the conversation information is still used. While discussing the same target topic by transmitting conversation information, a conversation object on the conversation interface may intersperse other conversation information (that is, irrelevant information) that is irrelevant to the target topic or has a small association (for example, the association is less than an association threshold, and the association is obtained by calculating a similarity between the conversation information and the target topic). Therefore, a plurality of sub-areas corresponding to all involved positions may be displayed in a scattered manner on the progress bar (that is, the sub-areas are not adjacent to each other), to indicate that there are a plurality of pieces of sub-topic content related to the target topic in the conversation information. One sub-area corresponds to one piece of sub-topic content, and a size of each sub-area (for example, an area occupied by the sub-area on the progress bar) represents an amount of corresponding sub-topic content. All the sub-areas are combined to form the target area, and all the sub-topic content related to the target topic forms the entire topic content of the target topic. In other words, each piece of sub-topic content related to the target topic is partial content of the entire topic content corresponding to the target topic.

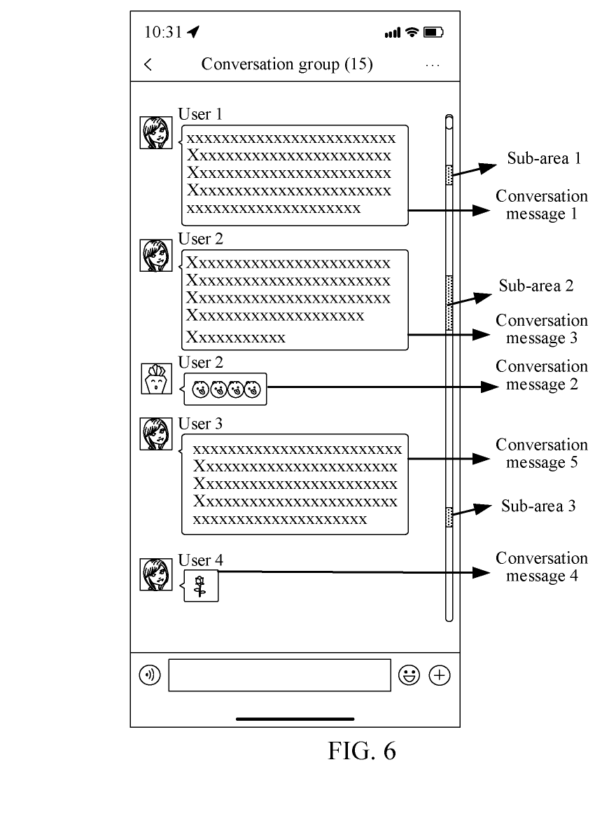

FIG. 6 is a schematic diagram of displaying topic indication information according to an embodiment of the present disclosure. An example in which an information page is a conversation page and media information is conversation information is used. Conversation information 1 of a user 1, conversation information 3 of a user 2, and conversation information 5 of a user 3 are information related to a target topic, and conversation information 2 of the user 2 and conversation information 4 of a user 4 are information irrelevant to the target topic. In this case, positions of the conversation information 1, the conversation information 3, and the conversation information 5 on the information page may be referred to as an involved position 1, an involved position 2, and an involved position 3 that correspond to the target topic. Therefore, when a target area corresponding to the involved position is displayed, a sub-area 1, a sub-area 2, and a sub-area 3 may be highlighted on a progress bar. The sub-area 1 corresponds to the involved position 1 (or the conversation information 1), the sub-area 2 corresponds to the involved position 2 (or the conversation information 3), and the sub-area 3 corresponds to the involved position 3 (or the conversation information 5). In this case, the sub-area 1, the sub-area 2, and the sub-area 3 are combined to be referred to as the target area. In this way, a user approximately learns of, based on a quantity and sizes of the sub-areas displayed on the progress bar in a scattered manner, an involved position of the related target topic in an entire conversation message and an amount of sub-topic content corresponding to each involved position, to approximately learn of the entire target topic, thereby improving user experience.

In some embodiments, the terminal may highlight the sub-areas corresponding to the involved positions on the progress bar in the following manner: separately obtaining an influence parameter configured for affecting display priorities of the sub-areas, the influence parameter including at least one of the following: a proportion of sub-topic content corresponding to the sub-area relative to total topic content corresponding to the target topic, interaction popularity of the sub-topic content corresponding to the sub-area, and/or object data of a target object of the sub-topic content (corresponding to the sub-area); invoking a neural network model to perform priority prediction based on the influence parameter, to obtain the display priorities of the sub-areas; and highlighting, on the progress bar by using display styles corresponding to the display priorities, the sub-areas corresponding to the involved positions.

Herein, when there are a plurality of involved positions of the target topic in the media information (topic content corresponding to the same target topic is scattered at different positions), and when the sub-areas of the involved positions are displayed on the progress bar, display priorities of different sub-areas may be different, and each sub-area may be displayed by using a corresponding display style based on a display priority of the sub-area. To be specific, sub-areas with different display priorities are displayed by using different display styles (for example, different display orders, different display colors, different display brightness, or different display fonts). For example, when there are three sub-areas, to be specific, a sub-area 1, a sub-area 2, and a sub-area 3, assuming that display priorities of the three sub-areas are in descending order, the sub-area 1 may be displayed in red font, the sub-area 2 may be displayed in yellow font, and the sub-area 3 may be displayed in gray font, so that the user distinguishes between the sub-areas of different display priorities, and triggers a needed sub-area, to quickly view topic content corresponding to the triggered sub-area. This helps improve pertinence and efficiency of displaying the topic content.

When a display priority of each sub-area is determined, the display priority of each sub-area may be predicted in a manner of artificial intelligence based on the influence parameter configured for affecting the display priority of each sub-area. When the influence parameter includes the proportion of the sub-topic content corresponding to the sub-area relative to the total topic content corresponding to the target topic, the proportion reflects the extent to which the sub-topic content corresponding to the corresponding sub-area constitutes the total topic content (that is, the topic content corresponding to the target area). For example, a ratio of a word count of the sub-topic content corresponding to the sub-area to a word count of the total topic content corresponding to the target topic may be used as the proportion of the sub-topic content corresponding to the sub-area relative to the total topic content corresponding to the target topic. Usually, a larger proportion indicates a higher display priority of a corresponding sub-area. When the influence parameter includes the interaction popularity of the sub-topic content corresponding to the sub-area, the interaction popularity is configured for reflecting interaction enthusiasm of the user for participating in the target topic, and may be measured by using a quantity of persons participating in interaction for the target topic, and a quantity and frequency of conversation information, transmitted by the user participating in the interaction, related to the target topic within a target time period. Usually, a larger quantity of persons in the interaction within the target time period or a larger quantity (or higher frequency) of conversation information, transmitted by the user participating in the interaction, related to the target topic within the target time period indicates higher interaction popularity, and a higher display priority corresponding to a corresponding sub-area.

In addition, the object data of the target object transmitting the sub-topic content corresponding to the sub-area may further be used as the influence parameter. An object characteristic includes, but is not limited to gender, level, job position, and historical interaction frequency of the target object. The target object is a user related to the sub-topic content, for example, a user initiating the sub-topic content (an initiator), a user participating in discussion of the sub-topic content (a participant), or an object discussed in the sub-topic content (a discussed user). The object data of the target object affects a display priority of the sub-area corresponding to the sub-topic content associated with the target object. Usually, when the target object has a higher level, a higher job position, or greater historical interaction frequency is higher, the display priority of the sub-area corresponding to the sub-topic content transmitted by the target object is higher.

After the influence parameter configured for affecting the display priority of the sub-area is obtained, prediction processing is performed in the neural network model trained based on the influence parameter, to obtain the display priority of the sub-area, so that the prediction can be more accurate. Before the neural network model is applied, an initial neural network model needs to be trained, and then the trained neural network model is put into use, to predict the display priority of the sub-area by using an artificial intelligence technology and based on the influence parameter. The neural network model is obtained through training by using an area sample, an influence parameter corresponding to the area sample, and a display priority marked for the area sample. For example, the initial neural network model is invoked to perform prediction processing based on the area sample, interaction popularity of sub-topic content corresponding to the area sample, and the display priority marked for the area sample, to obtain a predicted display priority. After a value of a loss function of the neural network model is determined by using the predicted display priority and the marked display priority, whether the value of the loss function exceeds a preset threshold may be determined. When the value of the loss function exceeds the preset threshold, an error signal of the neural network model is determined based on the loss function, the error signal is backpropagated in the neural network model, and a model parameter of each layer is updated in a propagation process.

A model structure of the neural network model is not limited in this embodiment of the present disclosure. For example, the neural network model may be a convolutional neural network, a deep neural network, or the like. A form of the loss function is also not limited. For example, the loss function may be a cross-entropy loss function, an L2 loss function, or the like.

Herein, the backpropagation is described. Training sample data is inputted to an input layer of the neural network model, passes through a hidden layer, and finally reaches an output layer and a result is outputted. This is a forward propagation process in the neural network model. Because there is an error between the outputted result of the neural network model and an actual result, the error between the outputted result and an actual value is calculated, and the error is backpropagated from the output layer to the hidden layer until the error is propagated to the input layer. In a backpropagation process, a value of the model parameter is adjusted based on the error, in other words, a loss function is constructed based on the error between the outputted result and the actual value, and a partial derivative of the loss function with respect to the model parameter is calculated layer by layer, to generate a gradient of the loss function with respect to the model parameter of each layer. Because a direction of the gradient indicates a direction in which the error expands, a negative of the gradient of the model parameter is taken and summed with an original parameter of a model of each layer. An obtained summation result is used as an updated model parameter of each layer, to reduce the error caused by the model parameter, and the foregoing process is continuously iterated until convergence is reached.

In some embodiments, the terminal may highlight the target area on the progress bar in the following manner: highlighting, when the target area includes a plurality of consecutive sub-areas, the sub-areas on the progress bar by using different filling colors, where sub-topic content corresponding to the sub-areas with different filling colors varies in terms of importance relative to the target topic, or sub-topic content corresponding to the sub-areas with different filling colors varies in terms of an opinion on the target topic.

In actual application, when there is only one target area, because there may be a plurality of pieces of information involving the target topic in the media information, each piece of information involving the target topic may be considered as sub-topic content of topic content related to the target topic. That is, the topic content of the target topic may be considered as including all pieces of sub-topic content, and therefore, the target area displayed on the progress bar may be considered as including the plurality of consecutive sub-areas. One sub-area corresponds to one piece of sub-topic content. Because importance or opinions of different sub-topic content relative to the target topic may be different, each sub-area may be highlighted on the progress bar by using different filling colors based on importance or an opinion of each piece of sub-topic content relative to the target topic. The filling color is configured for indicating the importance or the opinion of the sub-topic content corresponding to the sub-area.

An example in which the filling color is configured for indicating the importance of the sub-topic content corresponding to the sub-area is used. If the sub-topic content is more important relative to the target topic, a display color of the sub-area corresponding to the sub-topic content is darker; and if the sub-topic content is less important relative to the target topic, a display color of the sub-area corresponding to the sub-topic content is lighter. An example in which the filling color is configured for indicating the opinion of the sub-topic content corresponding to the sub-area is used. When the opinion of the sub-topic content relative to the target topic is a positive opinion, a display color of the sub-area corresponding to the sub-topic content is red; and when the opinion of the sub-topic content relative to the target topic is an opposite opinion, a display color of the sub-area corresponding to the sub-topic content is green. In this way, based on the filling color of the sub-area on the progress bar, the user may have initial cognition about the importance of or the opinion conveyed in the sub-topic content corresponding to each sub-area. When the user triggers a target sub-area, currently displayed content may be jumped to sub-topic content corresponding to the target sub-area in the media information for display, thereby improving pertinence and efficiency of viewing the topic content.

In some embodiments, the terminal may highlight the target area on the progress bar in the following manner: highlighting, when the target area includes the plurality of consecutive sub-areas, each sub-area carrying a directional identifier on the progress bar, where different directional identifiers are configured for indicating that sub-topic content corresponding to the corresponding sub-areas varies in terms of importance relative to the target topic, or different directional identifiers are configured for indicating that sub-topic content corresponding to the corresponding sub-areas varies in terms of an opinion on the target topic.

In actual application, when there is only one target area, because there may be a plurality of pieces of information involving the target topic in the media information, each piece of information involving the target topic may be considered as sub-topic content of topic content related to the target topic. That is, the topic content of the target topic may be considered as including all pieces of sub-topic content, and therefore, the target area displayed on the progress bar may be considered as including the plurality of consecutive sub-areas. One sub-area corresponds to one piece of sub-topic content. Because importance or opinions of different sub-topic content relative to the target topic may be different, each sub-area carrying the directional identifier may be highlighted on the progress bar based on importance or an opinion of each piece of sub-topic content relative to the target topic. The directional identifier is configured for indicating the importance or the opinion of the sub-topic content corresponding to the sub-area.

An example in which the directional identifier is configured for indicating the importance of the sub-topic content corresponding to the sub-area is used. When the importance of the sub-topic content relative to the target topic is unimportant, the directional identifier carried in the sub-area corresponding to the sub-topic content is "-"; and when the importance of the sub-topic content relative to the target topic is important, the directional identifier carried in the sub-area corresponding to the sub-topic content is "+". In addition, a larger importance degree indicates more "+" in the directional identifier. For example, when the sub-topic content is of ordinary importance, the directional identifier is "+"; when the sub-topic content is of intermediate importance, the directional identifier is "++"; and when the sub-topic content is of great importance, the directional identifier is "+++". An example in which the directional identifier is configured for indicating an opinion of sub-topic content corresponding to a sub-area is used. When the opinion of the sub-topic content relative to the target topic is a positive opinion, the directional identifier carried in the sub-area corresponding to the sub-topic content is an "upright triangle"; and when the opinion of the sub-topic content relative to the target topic is an opposite opinion, the directional identifier carried in the sub-area corresponding to the sub-topic content is an "inverted triangle". In this way, by using the directional identifier carried in each sub-area on the progress bar, the user may have initial cognition about the importance of or the opinion conveyed in the sub-topic content corresponding to each sub-area. When the user triggers a target sub-area, currently displayed content may be jumped to sub-topic content corresponding to the target sub-area in the media information for display, thereby improving pertinence and efficiency of viewing the topic content.

In some embodiments, the terminal may highlight the target area on the progress bar in the following manner: highlighting a plurality of target areas on the progress bar in response to that there are a plurality of target topics, where one target area corresponds to one target topic, and a proportion of the target area relative to the progress bar corresponds to a proportion of topic content corresponding to the target topic indicated by the target area relative to all content of the media information.

In actual application, when the media information on the information page involves a plurality of different target topics, a plurality of different target areas may be highlighted on the progress bar. One target area corresponds to one target topic, and the proportion of the target area relative to the progress bar (that is, a proportion of an area of the target area to an area of the entire progress bar) corresponds to the proportion of the topic content corresponding to the target topic indicated by the target area relative to all the content of the media information. That is, a larger area occupied by the target area indicates more corresponding topic content. In this way, based on a quantity and a size of target areas displayed on the progress bar, the user can clearly learn of a type of the involved target topic in the media information and an amount of topic content corresponding to each target topic. When the user triggers a specific target area, currently displayed content may be jumped to topic content corresponding to the triggered target area in the media information for display, thereby improving pertinence and efficiency of viewing the topic content.

In some embodiments, the terminal may highlight the plurality of target areas on the progress bar in the following manner: highlighting, on the progress bar, the plurality of target areas by using different display styles, one display style corresponding to one target topic.

In actual application, when the media information on the information page involves a plurality of different target topics, a plurality of different target areas may be highlighted on the progress bar by using different display styles (for example, different display colors, different display brightness, and different display fonts). One display style corresponds to one target area. That is, one display style corresponds to one target topic. For example, assuming that there are three target topics, to be specific, a target topic 1, a target topic 2, and a target topic 3 in the media information, on the progress bar, a target area 1 (corresponding to the target topic 1) is displayed by using a first display style, a target area 2 (corresponding to the target topic 2) is displayed by using a second display style, and a target area 3 (corresponding to the target topic 3) is displayed by using a third display style. In this way, based on a type of the display style of the target area on the progress bar, the user can clearly learn of a type of the involved target topic in the media information. When the user triggers a specific target area (for example, the target area 3), currently displayed content may be jumped to topic content of the target topic 3 corresponding to the triggered target area (for example, the target area 3) in the media information for display, thereby improving pertinence and efficiency of viewing the topic content.

In some embodiments, the terminal may highlight the plurality of target areas on the progress bar in the following manner: obtaining an influence factor configured for affecting a display order of the target areas, the influence factor including at least one of the following: a position that is of the topic content corresponding to the target topic indicated by the target area and that is in the media information, topic popularity corresponding to the target topic indicated by the target area, and/or object data of a target object corresponding to the target topic indicated by the target area; querying correspondences between different influence factors and different display orders based on the influence factor, and using a display order obtained through querying as the display orders of the target areas; and highlighting the target areas on the progress bar in the display order of the target areas.

In actual application, when the media information on the information page involves a plurality of different target topics, and when the target areas corresponding to the target topics are displayed on the progress bar, the display order of the target areas may be determined based on the influence factor that affects the display order of the target areas. Usually, a higher position that is of the topic content corresponding to the target topic indicated by the target area and that is in the media information indicates a higher display order of the corresponding target area.

The topic popularity corresponding to the target topic indicated by the target area may be represented based on interaction popularity, for the target topic, of a user participating in the topic. The interaction popularity (or the topic popularity) is configured for reflecting interaction enthusiasm of the user for participating in the target topic, and may be measured by using a quantity of persons participating in interaction for the target topic, and a quantity and frequency of conversation information, transmitted by the user participating in the interaction, related to the target topic within a target time period. Usually, a larger quantity of persons in the interaction within the target time period or a larger quantity (or higher frequency) of conversation information, transmitted by the user participating in the interaction, related to the target topic within the target time period indicates higher interaction popularity (that is, the topic popularity), and a higher display order of a corresponding target area.

Object data of the target object corresponding to the target topic indicated by the target area includes, but is not limited to, gender, level, job position, historical interaction frequency, and the like of the target object. The target object is a user related to the target topic, for example, may be a user initiating the target topic (an initiator), a user participating in discussion of the target topic (a participant), or an object discussed in the target topic (a discussed user). The object data of the target object affects a display order of the target area corresponding to the target topic associated with the target object. For example, when the target object has a higher level, a higher job position, or greater historical interaction frequency is higher, a display order corresponding to the target topic initiated by the target object is higher.

After the influence factor configured for affecting the display order of the target areas is obtained, a display order corresponding to the obtained influence factor may be queried from the correspondence, the display order obtained through querying is used as the display orders of the target areas, and the target areas are highlighted on the progress bar in the display order of the target areas.

For example, each target area on the progress bar is highlighted in a display manner in which the topic content corresponding to the target topic indicated by each target area is located at a high position in the media information and the display order of the corresponding target area on the progress bar is located at a high position. To be specific, the topic content corresponding to the target topic indicated by the target area is located at a higher position in the media information, and the display order of the corresponding target area on the progress bar is located at a higher position. For example, topic content of a target topic 1 is segments 1 to 10 in the media information, and topic content of a target topic 2 is segments 15 to 23 in the media information. In this case, a display order of a target area 1 (corresponding to the target topic 1) is located higher than a display order of a target area 2 (corresponding to the target topic 2) on the progress bar.

For another example, each target area on the progress bar is highlighted in a display manner in which the topic popularity corresponding to the target topic indicated by each target area is higher and a display order of the corresponding target area on the progress bar is higher. For another example, an example in which the information page is an enterprise group conversation page and the target object is the initiator of the target topic is used. Each target area on the progress bar is highlighted in a display manner in which the level of the target object corresponding to the target topic indicated by each target area is higher and the display order of the corresponding target area on the progress bar is higher. For example, if a target object 1 (a director) in an enterprise group initiates a target topic 1, and a target object 2 (a manager) initiates a target topic 2, because a level of the target object 1 (the director) is higher than a level of the target object 2 (the manager), a display order of a target area 1 corresponding to the target topic 1 is located higher than a display order of a target area 2 corresponding to the target topic 2 on the progress bar.

In the foregoing manner, the user can clearly learn of, based on display styles of target areas corresponding to different target topics on the progress bar, a category of the involved target topic in the media information, a position that is of the topic content corresponding to each target topic that is in the media information, the topic popularity of each target topic, or the like. When the user triggers a specific target area, currently displayed content may be jumped to topic content of target topic corresponding to the triggered target area in the media information for display, thereby improving pertinence and efficiency of viewing the topic content.

In some embodiments, the terminal may further display a corresponding area identifier at an associated position of each target area in a process of highlighting the plurality of target areas on the progress bar, where the area identifier is configured for indicating a position that is of the target topic corresponding to the corresponding target area and that is in the media information, or configured for indicating the topic popularity of the target topic corresponding to the corresponding target area, or configured for indicating historical trigger frequency corresponding to the corresponding target area.

In actual application, when the media information on the information page involves a plurality of different target topics, and when the target area corresponding to each target topic is displayed on the progress bar, the corresponding area identifier may be displayed at the associated position of each target area. For example, when each target area on the progress bar is highlighted in the display manner in which the topic popularity corresponding to the target topic indicated by each target area is higher and the display order of the corresponding target area on the progress bar is higher, because the display order of each target area on the progress bar cannot reflect the position that is of the topic content corresponding to the target topic indicated by the target area and that is in the media information, the area identifier may be configured for indicating the position that is of the target topic corresponding to the corresponding target area and that is in the media information. In this way, the user can clearly learn of, by using the area identifier associated with each target area on the progress bar, a relative position that is of the topic content corresponding to the target topic indicated by each target area and that is in the media information.

In addition, the area identifier may further be configured for indicating the topic popularity of the target topic corresponding to the corresponding target area. When topic popularity corresponding to different target topics is different, different area identifiers may be configured for representing the topic popularity of the corresponding target topic. For example, when a quantity of area identifiers "*" is configured for representing the topic popularity, higher topic popularity of a target topic corresponds to a larger quantity of area identifiers ("*") that are associatively displayed in a corresponding target area. In this way, the user may clearly learn of, by using the area identifier associated with each target area on the progress bar, the topic popularity of the target topic indicated by each target area, so that the user can quickly locate and view topic content corresponding to a needed target topic therefrom. This helps improve pertinence and efficiency of displaying the topic content.

In addition, the area identifier may be further configured for indicating the historical trigger frequency corresponding to the corresponding target area, that is, configured for indicating frequency at which the topic content of the target topic corresponding to the corresponding target area is viewed. In this way, the user may clearly learn of, by using the area identifier associated with each target area on the progress bar, the frequency at which the topic content of the target topic indicated by each target area is viewed, so that the user can quickly locate and view topic content corresponding to a needed target topic therefrom. This helps improve pertinence and efficiency of displaying the topic content.

In some embodiments, the terminal may display the topic indication information corresponding to the target topic in the following manner: displaying, at a specified position on the information page, the topic indication information that carries a topic tag and the target topic.

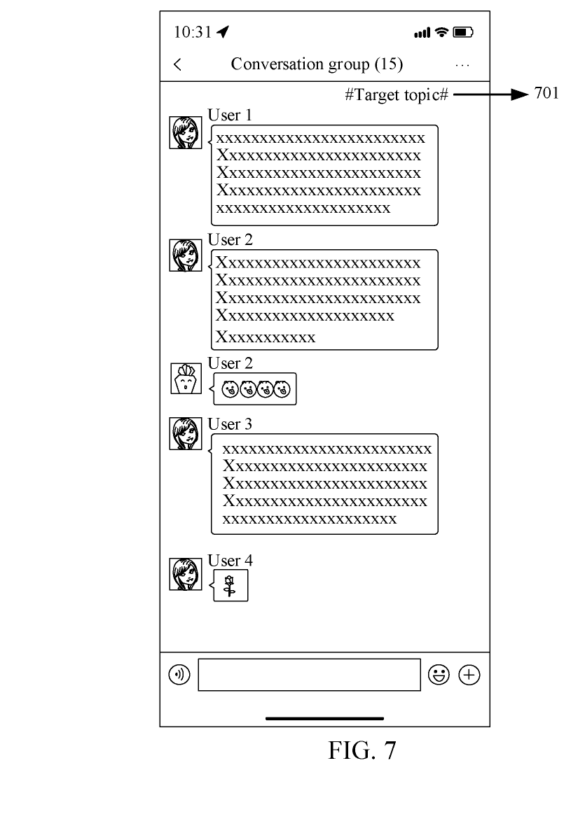

FIG. 7 is a schematic diagram of displaying topic indication information according to an embodiment of the present disclosure. Topic indication information 701 in a style of "#Target topic#" may be displayed at a specified position (a related position that does not affect viewing of media information) on an information page. "#...#" is a topic tag. In this way, a user is reminded that the media information involves the target topic, so that the user can view topic content of the target topic in a targeted manner.

In some embodiments, the terminal may display the topic indication information corresponding to the target topic in the following manner: displaying, on the information page, a topic control corresponding to the target topic, and using the topic control as the topic indication information.

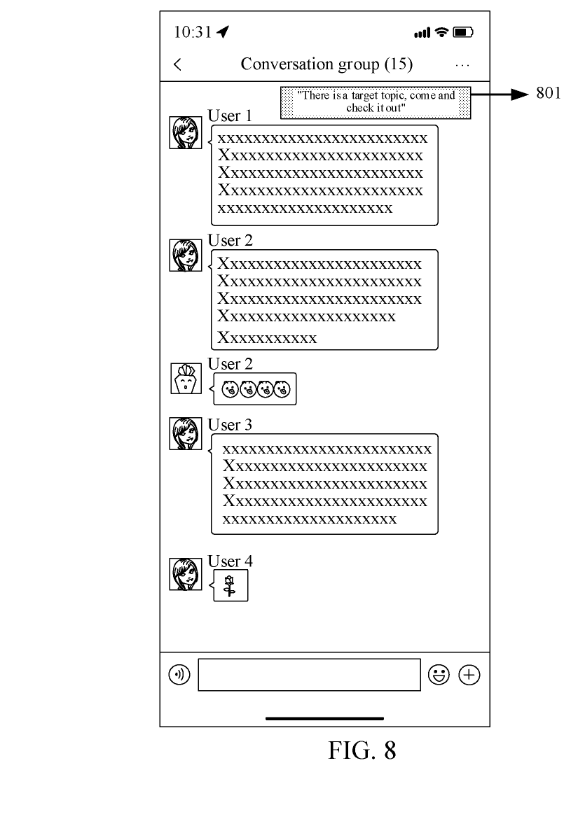

FIG. 8 is a schematic diagram of displaying topic indication information according to an embodiment of the present disclosure. A terminal may directly display topic indication information 801 in a style of "there is a target topic, come and check it out" at a specified position (a related position that does not affect viewing of media information) on an information page, to attract a user to trigger the topic indication information to view topic content of the target topic. In addition, a topic control (for example, a topic button) corresponding to the target topic may be further displayed on the information page as the topic indication information. When the media information involves a plurality of target topics, a plurality of topic controls may be displayed (to be specific, one topic control corresponds to one target topic). The user triggers the topic control to view the topic content of the corresponding target topic.

In some embodiments, the terminal may display the topic indication information corresponding to the target topic in the following manner: dynamically presenting, by using a first sub-page independent of the information page, at least one interactive element corresponding to the target topic, and using the interactive element as the topic indication information.

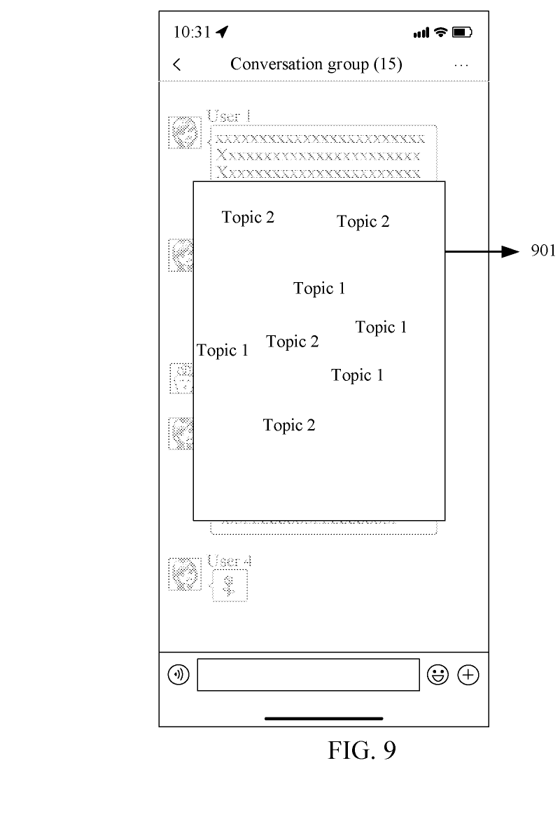

The interactive element may be displayed on the first sub-page in a form of a functional item, a text chain, or an indication connection. For example, when the interactive element is displayed on the first sub-page in a form of the text chain, a text chain of "click/tap me to view the target topic" may be displayed on the first sub-page, and the user clicks/taps the text chain to view the topic content of the target topic. Alternatively, the interactive element may be a plurality of sticker elements that are dynamically presented. FIG. 9 is a schematic diagram of displaying topic indication information according to an embodiment of the present disclosure. When the interactive element is displayed on a first sub-page 901 in a form of the plurality of sticker elements that are dynamically presented, the first sub-page dynamically presents the plurality of sticker elements corresponding to a target topic (to be specific, the topic indication information of the target topic is dynamically presented in a manner of a sticker rain (for example, a plurality of clickable/tappable topics is displayed)). A user may click/tap a target sticker element in the plurality of sticker elements that are dynamically presented, to view topic content of the target topic. In this way, diversity and interactivity of display of the topic indication information can be improved.

Operation 103: Display the topic content on the information page in response to a trigger operation for the topic indication information.

Herein, when the user triggers the topic indication information, the terminal displays the topic content corresponding to the target topic on the information page in response to the trigger operation. In other words, content displayed on the information page of the terminal before the topic indication information is triggered is jumped to the topic content that corresponds to the target topic and that is in the media information for display. This can improve pertinence and efficiency of viewing the topic content.

In some embodiments, the terminal may display the topic content on the information page in the following manner: sliding the media information to a target position when information content currently displayed on the information page is irrelevant to the target topic, and switching the information content to topic content located at the target position for display, where the target position includes at least one of the following: a start position of the target topic, a position of engaging topic content corresponding to the target topic, and/or a position of topic content posted by the target object on the target topic.

Herein, when the information content currently displayed on the information page is irrelevant to the target topic, and the user triggers the topic indication information, the terminal slides the media information to the target position corresponding to the target topic in response to the trigger operation, and displays, at the target position, the topic content located at the target position.

The target position may be the start position of the target topic (that is, a position at which the target topic is opened in the media information). The content currently displayed on the information page is positioned at the start position of the target topic, and the user may start to view the topic content of the target topic from the start position of the target topic, so that the user can fully learn of the target topic globally. The target position may alternatively be the position of the engaging topic content corresponding to the target topic. The engaging topic content may be content having highest interaction popularity related to the target topic, or may be summary content summarizing the target topic. The content currently displayed on the information page is positioned at a position of the engaging topic content of the target topic, so that the user quickly learns of the engaging content of the target topic, thereby improving pertinence and efficiency of viewing the topic content. The target position may alternatively be the position of the topic content posted by the target object on the target topic. The content currently displayed on the information page is positioned at the position of the topic content posted by the target object on the target topic, so that the user quickly locates and views an opinion of a particular object on the target topic, for example, locates content posted by a manager in an enterprise conversation group on a target topic, or locates content posted by a head teacher in a class conversation group on a target topic. This can improve pertinence and efficiency of viewing the topic content.

In some embodiments, the terminal may display the topic content on the information page in the following manner: displaying the topic content on the information page by using an overlay or a pop-up window; or displaying the topic content by using a second sub-page independent of the information page, the second sub-page having preset transparency.

In actual application, when the topic content of the target topic is displayed, the topic content may further be displayed by using the overlay. A size of the overlay may be set based on an actual requirement. When there is a large amount of topic content, a large overlay may be presented to completely display the topic content, or a small overlay may be displayed to display a part of the topic content. In this case, the overlay may be associated with a progress pull-down bar, and a remaining part of topic content may be displayed by dragging the progress pull-down bar. In addition, the topic content corresponding to the target topic may be displayed by using the pop-up window floating on the information page. A display position of the pop-up window on the information page is synchronously moved along with a dragging operation of the user. In addition, the topic content may be displayed by using the second sub-page independent of the information page. The second sub-page may have the preset transparency, and related content of the media information of the information page below may be seen by using the second sub-page, to meet an information diversification requirement for presentation.

In some embodiments, after displaying the topic content on the information page, the terminal may further display extended topic content in the following manner: displaying an extension entry corresponding to the topic content; and jumping to an extension page from the information page in response to a trigger operation for the extension entry, and displaying the extended topic content on the extension page.

The extension entry is configured for displaying the extended topic content for the target topic. The extension entry may exist in a form of a web page link, a keyword carrying a topic tag (for example, #), or the like.

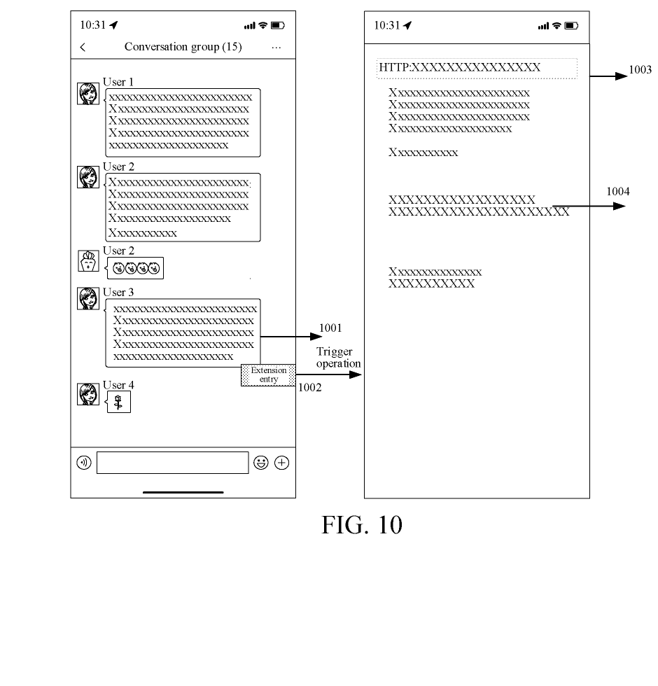

FIG. 10 is a schematic diagram of displaying extended topic content according to an embodiment of the present disclosure. While displaying, on a current information page, topic content 1001 related to an involved target topic in media information, a terminal may further display an extension entry 1002 for extending the topic content 1001, and jump to an extension page from the information page in response to a trigger operation for the extension entry 1002. For example, when the extension entry 1002 is a web page link, the extension page is a web page 1003 indicated by the web page link, and extended topic content 1004 related to the target topic, for example, a discussion related to the target topic on the Internet, is displayed on the extension page 1003. In this way, a user not only can view related content related to the target topic of the media information on the information page, but also can view related content related to the target topics other than the media information on the information page, thereby meeting a requirement of the user for obtaining diversified information.

In the foregoing manner, in a process of sliding the media information on the information page, if the media information on the information page involves the target topic, the terminal displays the topic indication information corresponding to the target topic. Because the topic indication information is configured for indicating that there is the topic content corresponding to the target topic in the media information, the user can conveniently perceive that there is the related content of the target topic in the media information. In addition, when receiving the trigger operation for the topic indication information, the terminal directly displays the topic content on the information page. In this way, the topic content of the target topic can be located and displayed for the user on the information page without sliding the media information on the information page to a position of the related content of the target topic, thereby improving efficiency of obtaining the topic content.

The following describes an exemplary application of this embodiment of the present disclosure in an actual application scenario. The media information processing method provided in this embodiment of the present disclosure continues to be described by using an example in which the information page is the conversation page and the topic indication information is displayed in the target area on the progress bar.

In actual application, users participating in a conversation communicate by transmitting conversation information on a conversation page, and a terminal receives x (x is a positive integer) pieces of conversation information (that is, the foregoing media information) on the conversation page, and may mark identifiers of the pieces of conversation information as (M1, M2, …, Mx) based on a display order of the conversation information on the conversation page. Then, the terminal performs topic identification on the pieces of conversation information by using a local semantic understanding model, and determines, based on a topic identification result, whether the pieces of conversation information involve a specific topic. When the topic identification result represents that the pieces of conversation information involve a plurality of topics, for example, it is identified therefrom that a message interval (Ma–Mb) corresponds to a topic 1, and (Mc–Md) corresponds to a topic 2 (the topic 1 and the topic 2 are independent of each other), the terminal displays topic indication information configured for indicating that the conversation information involves the topic 1 and the topic 2. For example, a progress bar is displayed in an edge area (for example, the rightmost side) of the conversation page, a target area 1 and a target area 2 are highlighted on the progress bar, and the target area 1 and the target area 2 that are highlighted on the progress bar are used as the topic indication information. The target area 1 is configured for indicating that the conversation information involves the topic 1, and the target area 2 is configured for indicating that the conversation information involves the topic 2.

An implementation of the foregoing progress bar is: It is assumed that a length of an information page loaded by default is Y0, the terminal loads more page lengths sequentially as the page slides, a length of a page loaded each time is Yn, and an entire length of the progress bar is set to y. The length y of the progress bar keeps a mapping ratio with the page length Y0, and when the user drags the progress bar, the information page also slides a distance in the same ratio according to the mapping ratio.

When display positions of the target area 1 and the target area 2 on the progress bar are determined, the terminal positions a starting point Ma of the information interval (Ma–Mb) and an information length of (Ma–Mb), positions a starting point Mc of the information interval (Mc–Md) and an information length of (Mc–Md), and performs mapping by using a mapping ratio, to obtain a topic position interval of the target area 1 corresponding to the topic 1 on the progress bar and a topic position interval of the target area 2 corresponding to the topic 2 on the progress bar. Then, the terminal performs dyeing on the topic position intervals (that is, the target area 1 and the target area 2) on the progress bar, for example, dyeing in green, to visually remind the user. For example, the target area 1 displayed in green is for reminding the user that conversation information involves the topic 1, and the target area 2 displayed in green is for reminding the user that conversation information involves the topic 2.

When the user clicks/taps the topic indication information highlighted on the progress bar, the topic content (that is, conversation information related to the topic) corresponding to the topic indicated by the topic indication information on the conversation page can be quickly positioned. For example, when the user clicks/taps the target area 1 on the progress bar, the terminal quickly positions the starting point Ma of the information interval (Ma–Mb) corresponding to the topic 1, and displays the information interval (Ma–Mb) corresponding to the topic 1 on a current information page. When the user clicks/taps the target area 2 on the progress bar, the terminal quickly positions the starting point Mc of the information interval (Mc–Md) corresponding to the topic 2, and displays the information interval (Mc–Md) corresponding to the topic 2 on a current information page. In this way, pertinence and efficiency of positioning the topic content can be improved.

The media information processing method provided in embodiments of the present disclosure has been described with reference to exemplary applications and implementations of the electronic device provided in embodiments of the present disclosure. The following continues to describe a media information processing solution cooperatively implemented by modules in a media information processing apparatus 555 provided in embodiments of the present disclosure.

A page sliding module 5551 is configured to slide media information on an information page in response to a sliding operation for the media information on the information page; a first display module 5552 is configured to: in response to that the media information involves a target topic, display topic indication information corresponding to the target topic, the topic indication information being configured for indicating that there is topic content corresponding to the target topic in the media information; and a second display module 5553 is configured to display the topic content on the information page in response to a trigger operation for the topic indication information.

In some embodiments, after the sliding media information on the information page, the apparatus further includes: a progress bar display module, configured to display a progress bar at an edge position on the information page in a process of sliding the media information, the progress bar being configured for indicating a sliding progress for the information page. The first display module is further configured to: highlight a target area on the progress bar, and use the highlighted target area as the topic indication information corresponding to the target topic, where a relative position of the target area on the progress bar is configured for indicating an involved position of the target topic in the media information.

In some embodiments, the first display module is further configured to: in response to that there are a plurality of involved positions of the target topic in the media information, highlight, on the progress bar, sub-areas corresponding to the involved positions, and use an area obtained by combining all the sub-areas as the target area.

In some embodiments, the first display module is further configured to: separately obtain an influence parameter configured for affecting display priorities of the sub-areas, the influence parameter including at least one of the following: a proportion of sub-topic content corresponding to the sub-area relative to total topic content corresponding to the target topic, interaction popularity of the sub-topic content corresponding to the sub-area, and/or object data of a target object of the sub-topic content; invoke a neural network model to perform priority prediction based on the influence parameter, to obtain the display priorities of the sub-areas; and highlight, on the progress bar by using display styles corresponding to the display priorities, the sub-areas corresponding to the involved positions.

In some embodiments, the first display module is further configured to highlight, when the target area includes a plurality of consecutive sub-areas, the sub-areas on the progress bar by using different filling colors, where sub-topic content corresponding to the sub-areas with different filling colors varies in terms of importance relative to the target topic, or sub-topic content corresponding to the sub-areas with different filling colors varies in terms of an opinion on the target topic.

In some embodiments, the first display module is further configured to highlight, when the target area includes the plurality of consecutive sub-areas, each sub-area carrying a directional identifier on the progress bar, where different directional identifiers are configured for indicating that sub-topic content corresponding to the corresponding sub-areas varies in terms of importance relative to the target topic, or different directional identifiers are configured for indicating that sub-topic content corresponding to the corresponding sub-areas varies in terms of an opinion on the target topic.

In some embodiments, the first display module is further configured to highlight a plurality of target areas on the progress bar in response to that there are a plurality of target topics, where one target area corresponds to one target topic, and a proportion of the target area relative to the progress bar corresponds to a proportion of topic content corresponding to the target topic indicated by the target area relative to all content of the media information.

In some embodiments, the first display module is further configured to highlight, on the progress bar, the plurality of target areas by using different display styles, one display style corresponding to one target topic.

In some embodiments, the first display module is further configured to: obtain an influence factor configured for affecting a display order of the target areas, the influence factor including at least one of the following: a position that is of the topic content corresponding to the target topic indicated by the target area and that is in the media information, topic popularity corresponding to the target topic indicated by the target area, and/or object data of a target object corresponding to the target topic indicated by the target area; query correspondences between different influence factors and different display orders based on the influence factor, and use a display order obtained through querying as the display orders of the target areas; and highlight the target areas on the progress bar in the display order of the target areas.

In some embodiments, the apparatus further includes: an identifier display module, configured to: display a corresponding area identifier at an associated position of each target area in a process of highlighting the plurality of target areas on the progress bar, where the area identifier is configured for indicating a position that is of the target topic corresponding to the corresponding target area and that is in the media information, or configured for indicating the topic popularity of the target topic corresponding to the corresponding target area, or configured for indicating historical trigger frequency corresponding to the corresponding target area.

In some embodiments, the apparatus further includes: an expansion control module, configured to: control, in response to a trigger operation for the progress bar, the progress bar to be expanded, and control the target area to be synchronously expanded as the progress bar is expanded, where the target area is expanded to improve trigger convenience for the area.

In some embodiments, the first display module is further configured to display, at a specified position on the information page, the topic indication information that carries a topic tag and the target topic.

In some embodiments, the first display module is further configured to: display, on the information page, a topic control corresponding to the target topic, and use the topic control as the topic indication information.

In some embodiments, the first display module is further configured to: dynamically present, by using a first sub-page independent of the information page, at least one interactive element corresponding to the target topic, and use the interactive element as the topic indication information.

In some embodiments, the second display module is further configured to: slide the media information to a target position when information content currently displayed on the information page is irrelevant to the target topic, and switch the information content to topic content located at the target position for display, where the target position includes at least one of the following: a start position of the target topic, a position of engaging topic content corresponding to the target topic, and/or a position of topic content posted by the target object on the target topic.

In some embodiments, the second display module is further configured to: display the topic content on the information page by using an overlay or a pop-up window; or display the topic content by using a second sub-page independent of the information page, the second sub-page having preset transparency.

In some embodiments, after the displaying the topic content on the information page, the apparatus further includes: an extension module, configured to: display an extension entry corresponding to the topic content, the extension entry being configured for displaying extended topic content for the target topic; and jump to an extension page from the information page in response to a trigger operation for the extension entry, and display the extended topic content on the extension page.

An embodiment of the present disclosure provides a computer program product. The computer program product includes a computer program or computer-executable instructions. The computer program or computer-executable instructions are stored in a computer-readable storage medium. A processor of an electronic device reads the computer-executable instructions from the computer-readable storage medium, and the processor executes the computer-executable instructions to cause the electronic device to perform the media information processing method according to embodiments of the present disclosure.

An embodiment of the present disclosure provides a computer-readable storage medium storing computer-executable instructions, having the computer-executable instructions or a computer program stored therein. When the computer-executable instructions or the computer program is executed by a processor, the processor is caused to perform the xx method according to embodiments of the present disclosure, for example, the media information processing method shown in FIG. 3.

In some embodiments, the computer-readable storage medium may be a memory such as an FRAM, a ROM, a PROM, an EPROM, an EEPROM, a flash memory, a magnetic surface memory, an optical disk, or a CD-ROM; or may be any device including one of or any combination of the foregoing memories.

In some embodiments, the computer-executable instructions may be written in the form of program, software, software module, script, or code in any form of programming language (including compilation or interpretation language, or declarative or procedural language), and the computer-executable instructions may be deployed in any form, including being deployed as an independent program or being deployed as a module, component, subroutine, or another unit suitable for use in a computing environment.

In an example, the computer-executable instructions may, but do not necessarily, correspond to a file in a file system, and may be stored in a part of a file that saves another program or other data, for example, be stored in one or more scripts in a HyperText Markup Language (HTML) file, stored in a single file that is specially used for a program in discussion, or stored in a plurality of collaborative files (for example, be stored in files of one or more modules, subprograms, or code parts).

In an example, the computer-executable instructions may be deployed to be executed on one electronic device, on a plurality of electronic devices located at one site, or on a plurality of electronic devices distributed at a plurality of positions and connected by a communication network.

Embodiments of the present disclosure have at least the following beneficial effects. As disclosed, in a process of sliding media information on an information page, if the media information on the information page involves a target topic, a terminal displays topic indication information corresponding to the target topic. Because the topic indication information is configured for indicating that there is topic content corresponding to the target topic in the media information, a user can conveniently perceive that there is related content of the target topic in the media information. In addition, when receiving a trigger operation for the topic indication information, the terminal directly displays the topic content on the information page. In this way, the topic content of the target topic can be located and displayed for the user on the information page without sliding the media information on the information page to a position of the related content of the target topic, thereby improving efficiency of obtaining the topic content.

The foregoing descriptions are only an example of the present disclosure and are not intended to limit the scope of protection of the present disclosure. Any modification, equivalent replacement, or improvement made within the spirit and scope of the present disclosure fall within the protection scope of the present disclosure.

What is claimed is:

1. A media information processing method, performed by an electronic device and comprising:
sliding media information on an information page in response to a sliding operation for the media information on the information page;
displaying, in response to that the media information involves a target topic, topic indication information corresponding to the target topic, the topic indication information being configured for indicating that the media information contains topic content corresponding to the target topic; and
displaying the topic content on the information page in response to a trigger operation for the topic indication information.

2. The method according to claim 1, further comprising:
displaying a progress bar at an edge position of the information page in a process of sliding the media information, the progress bar being configured for indicating a sliding progress for the information page, wherein
displaying the topic indication information corresponding to the target topic comprises:
highlighting a target area on the progress bar, and using the highlighted target area as the topic indication information corresponding to the target topic, wherein
a relative position of the target area on the progress bar is configured for indicating an involved position where the target topic is involved in the media information.

3. The method according to claim 2, wherein highlighting the target area on the progress bar comprises:
in response to there being a plurality of involved positions of the target topic in the media information, highlighting, on the progress bar, sub-areas corresponding to the involved positions, and using an area obtained by combining all the sub-areas as the target area.

4. The method according to claim 3, wherein highlighting, on the progress bar, the sub-areas corresponding to the involved positions comprises:
respectively obtaining an influence parameter configured for affecting display priorities of the sub-areas, the influence parameter comprising at least one of following: a proportion of sub-topic content corresponding to the sub-area relative to total topic content corresponding to the target topic, interaction popularity of the sub-topic content corresponding to the sub-area, or object data of a target object of the sub-topic content;
invoking a neural network model to perform priority prediction based on the influence parameter, to obtain the display priorities of the sub-areas; and
highlighting, on the progress bar by using display styles corresponding to the display priorities, the sub-areas corresponding to the involved positions.

5. The method according to claim 2, wherein highlighting the target area on the progress bar comprises:
highlighting, when the target area comprises a plurality of consecutive sub-areas, sub-areas on the progress bar by using different filling colors, wherein
sub-topic content corresponding to the sub-areas with different filling colors varies in terms of importance relative to the target topic, or sub-topic content corresponding to the sub-areas with different filling colors varies in terms of an opinion on the target topic.

6. The method according to claim 2, wherein highlighting the target area on the progress bar comprises:
highlighting, when the target area comprises the plurality of consecutive sub-areas, a sub-area carrying a directional identifier on the progress bar, wherein
different directional identifiers are configured for indicating that sub-topic content corresponding to the corresponding sub-areas varies in terms of importance relative to the target topic, or different directional identifiers are configured for indicating that sub-topic content corresponding to the corresponding sub-areas varies in terms of an opinion on the target topic.

7. The method according to claim 2, wherein highlighting the target area on the progress bar comprises:
highlighting a plurality of target areas on the progress bar in response to there being a plurality of target topics, wherein
one target area corresponds to one target topic, and a proportion of the target area relative to the progress bar corresponds to a proportion of topic content corresponding to the target topic indicated by the target area relative to all content of the media information.

8. The method according to claim 7, wherein highlighting the plurality of target areas on the progress bar comprises:
highlighting, on the progress bar, the plurality of target areas by using different display styles, one display style corresponding to one target topic.

9. The method according to claim 7, wherein highlighting the plurality of target areas on the progress bar comprises:
obtaining an influence factor configured for affecting a display order of the target areas, the influence factor comprising at least one of following: a position, within the media information, of the topic content corresponding to the target topic indicated by the target area, topic popularity corresponding to the target topic indicated by the target area, or object data of a target object corresponding to the target topic indicated by the target area;
querying correspondences between different influence factors and different display orders based on the influence factor, and using display orders obtained through querying as the display orders of the target areas; and
highlighting the target areas on the progress bar according to the display orders of the target areas.

10. The method according to claim 7, further comprising:
displaying a corresponding area identifier at an associated position of each target area in a process of highlighting the plurality of target areas on the progress bar, wherein
the area identifier is configured for indicating a position, within the media information, of the target topic corresponding to the corresponding target area, or configured for indicating the topic popularity of the target topic corresponding to the corresponding target area, or configured for indicating a historical trigger frequency corresponding to the corresponding target area.

11. The method according to claim 2, further comprising:
controlling, in response to a trigger operation for the progress bar, the progress bar to be expanded, and controlling the target area to be synchronously expanded as the progress bar is expanded, wherein
the target area is expanded to improve trigger convenience for the area.

12. The method according to claim 1, wherein displaying the topic indication information corresponding to the target topic comprises:
displaying, at a specified position on the information page, the topic indication information that carries a topic tag and the target topic.

13. The method according to claim 1, wherein displaying the topic indication information corresponding to the target topic comprises:
displaying, on the information page, a topic control corresponding to the target topic, and using the topic control as the topic indication information.

14. The method according to claim 1, wherein displaying the topic indication information corresponding to the target topic comprises:
dynamically presenting, by using a first sub-page independent of the information page, at least one interactive element corresponding to the target topic, and using the interactive element as the topic indication information.

15. The method according to claim 1, wherein displaying the topic content on the information page comprises:
sliding the media information to a target position when information content currently displayed on the information page is irrelevant to the target topic, and switching the information content to topic content located at the target position for display, wherein
the target position comprises at least one of following: a start position of the target topic, a position of engaging topic content corresponding to the target topic, or a position of topic content posted by the target object on the target topic.

16. The method according to claim 1, wherein displaying the topic content on the information page comprises:
displaying the topic content on the information page by using an overlay or a pop-up window; or
displaying the topic content by using a second sub-page independent of the information page, the second sub-page having preset transparency.

17. The method according to claim 1, further comprising:
displaying an extension entry corresponding to the topic content, the extension entry being configured for displaying extended topic content for the target topic; and
jumping to an extension page from the information page in response to a trigger operation for the extension entry, and displaying the extended topic content on the extension page.

18. An electronic device, comprising:
one or more processors and a memory containing computer-executable instructions or a computer program that, when being executed, cause the one or more processors to perform:
sliding media information on an information page in response to a sliding operation for the media information on the information page;
displaying, in response to that the media information involves a target topic, topic indication information corresponding to the target topic, the topic indication information being configured for indicating that the media information contains topic content corresponding to the target topic; and
displaying the topic content on the information page in response to a trigger operation for the topic indication information.

19. The electronic device according to claim 18, wherein the one or more processors are further configured to perform:
displaying a progress bar at an edge position of the information page in a process of sliding the media information, the progress bar being configured for indicating a sliding progress for the information page, and
highlighting a target area on the progress bar, and using the highlighted target area as the topic indication information corresponding to the target topic, wherein
a relative position of the target area on the progress bar is configured for indicating an involved position where the target topic is involved in the media information.

20. A non-transitory computer-readable storage medium containing computer-executable instructions or a computer program that, when being executed, cause at least one processor for performing:
sliding media information on an information page in response to a sliding operation for the media information on the information page;
displaying, in response to that the media information involves a target topic, topic indication information corresponding to the target topic, the topic indication information being configured for indicating that the media information contains topic content corresponding to the target topic; and
displaying the topic content on the information page in response to a trigger operation for the topic indication information.
